(19) United States
(12) Patent Application Publication
(10) Pub. No.: US 2026/0112602 A1
(43) Pub. Date: Apr. 23, 2026

(54) POSITIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventor: Naoya MORISAWA, Yongin-si (KR)

(73) Assignee: SAMSUNG SDI CO., LTD., Yongin-si (KR)

(21) Appl. No.: 19/348,157

(22) Filed: Oct. 2, 2025

(30) Foreign Application Priority Data
Oct. 21, 2024 (KR) 10-2024-0144222

(51) Int. Cl. H01M 4/131; H01M 4/02; H01M 4/36; H01M 4/525; H01M 10/052; H01M 50/107

(52) U.S. Cl. CPC H01M 4/131; H01M 4/364; H01M 4/525; H01M 10/052; H01M 50/107; H01M 2004/021; H01M 2004/028

(57) ABSTRACT

Disclosed are a positive electrode for a rechargeable lithium battery and a rechargeable lithium battery. The positive electrode for the rechargeable lithium battery includes a current collector, a positive electrode active material layer disposed on the current collector, wherein the positive electrode active material layer includes a section I, a section II, and a section III in a width direction. The section I and the section III are positioned at an edge in the width direction of the positive electrode active material, and the section II is positioned between the section I and the section III. The porosity of the section II is in a range of about 5% to about 20% greater than porosities of the section I and the section III.

### CROSS-REFERENCE TO RELATED APPLICATION

This application claims priority to Korean Patent Application No. 10-2024-0144222 filed with the Korean Intellectual Property Office on Oct. 21, 2024, the entire contents of which are incorporated herein by reference.

### BACKGROUND

### (a) Field

Example embodiments relate to a positive electrode for a rechargeable lithium battery, and a rechargeable lithium battery including the positive electrode.

### (b) Description of the Related Art

With increasing presence of electronic devices that use batteries such as, e.g., mobile phones, laptop computers, electric vehicles, and the like, the demand for high-energy density and high-capacity rechargeable lithium batteries is increasing. Improving the performance of rechargeable lithium batteries may be advantageous.

Rechargeable lithium batteries include a positive electrode and a negative electrode including an active material capable of intercalating and deintercalating lithium ions, and an electrolyte solution, and electrical energy is produced by oxidation and reduction reactions when if lithium ions are intercalated/deintercalated at the positive and negative electrodes.

### SUMMARY

One or more example embodiments include a positive electrode for a rechargeable lithium battery exhibiting desired or improved impregnation of the electrolyte. Another example embodiment includes a rechargeable lithium battery including the positive electrode.

One or more example embodiments include a positive electrode for a rechargeable lithium battery including a current collector; and a positive electrode active material layer on the current collector. The positive electrode active material layer includes a section I, a section II, and a section III in a width direction. The section I and the section III are positioned at an edge in the width direction of the positive electrode active material, and the section II is positioned between the section I and the section III. The porosity of the section II is in a range of about 5% to about 20% greater than porosities of the section I and the section III.

Another example embodiment includes a rechargeable lithium battery including the positive electrode; a negative electrode; and a non-aqueous electrolyte.

The positive electrode for a rechargeable lithium battery according to one or more example embodiments may include a rechargeable lithium battery exhibiting high-capacity, and desired or improved high rate charge characteristic and cycle-life characteristic.

### BRIEF DESCRIPTION OF THE DRAWINGS

FIG. 1 is a cross-sectional view schematically showing a positive electrode for a rechargeable lithium battery according to one or more example embodiment.

FIG. 2 is a plan view schematically showing a positive electrode for a rechargeable lithium battery according to one or more example embodiments.

FIG. 3 is a drawing defining a width of the section II of the positive electrode active material layer according to one or more example embodiments.

FIG. 4 to FIG. 7 are a cross-sectional view schematically showing rechargeable lithium batteries according to some example embodiments.

### DETAILED DESCRIPTION

Hereinafter, example embodiments are described in detail. However, these embodiments are examples, the present disclosure is not limited thereto, and the present disclosure is defined by the scope of claims.

As used herein, when if a specific definition is not otherwise provided, it is understood that when if an element such as a layer, film, region, or substrate is referred to as being “on” another element, the element can be directly on the other element, or intervening elements may also be present therebetween.

Unless otherwise specified in this specification, what is indicated in the singular may also include the plural. In addition, unless otherwise specified, “A or B” may mean “including A, including B, or including A and B.”

As used herein, the term “combination thereof” may include a mixture, a laminate, a complex, a copolymer, an alloy, a blend, a reactant of constituents.

In the present disclosure, when if a definition is not otherwise provided, a particle diameter may be an average particle diameter. The particle diameter indicates an average particle diameter (D50) where a cumulative volume is about 50 volume % in a particle size distribution. The average particle diameter (D50) may be measured by a method well known to those skilled in the art, for example, by a particle size analyzer, or by a transmission electron microscope (TEM) image, or a scanning electron microscope (SEM) image. In some example embodiments, a dynamic light-scattering measurement device may be used to perform a data analysis, and the number of particles may be counted for each particle size range, and from this, the average particle diameter (D50) value may be readily obtained through a calculation. The particle size may be measured by a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

In some example embodiments, an average particle diameter may be measured by various techniques, and for example, may be measured by a particle analyzer.

In some example embodiments, a thickness may be measured by a SEM or a TEM image for the cross-section, but is not limited thereto, and may be measured by any techniques, as long as the techniques may measure the thickness in the related arts. The thickness may be an average thickness.

As used herein, soft carbon refers to graphitizable carbon materials and are readily graphitized by heat treatment at a high temperature, e.g., about 2800° C., and hard carbon refers to non-graphitizable carbon materials and are substantially not graphitized, or slightly graphitized, by a heat treatment. The terms soft carbon and hard carbon may be well known in the related arts. In some example embodiments, the crystalline carbon and the amorphous carbon may be distinguished through XRD measurement. The crystalline carbon includes natural graphite and artificial graphite. Natural graphite may indicate graphite which may be naturally generated by separating the graphite from minerals, and when if measured by XRD, the interplanar spacing (d002) of the (002) plane may be in a range of about 3.350 Å to about 3.360 Å. Artificial graphite may indicate graphite manufactured by graphitization, and when if measured by XRD, the interplanar spacing (d002) of the (002) plane may be in a range of about 3.355 Å to about 3.365 Å. The amorphous carbon may have the interplanar spacing (d 002) of the (002) plane of about 3.34 Å or less, when if measured by XRD. The XRD may be measured using CuKα ray as a target line with an X-ray diffraction analyzer (e.g., product name: X'Pert, manufacturer: Malvern Panalytical) and by removing a monochromator to improve a peak density resolution. The measurement condition may be 2θ=10° to 80°, a scan speed (°/S) of 0.044 to 0.089, and a step size (°/step) of 0.013 to 0.039.

In some example embodiments, a weight-average-molecular weight may be measured by using gel permeation chromatography (GPC).

When if the terms “about” or “substantially” are used in this specification in connection with a numerical value, it is intended that the associated numerical value include a tolerance of ±10% around the stated numerical value. When if ranges are specified, the range includes all values therebetween such as increments of 0.1%.

A positive electrode for a rechargeable lithium battery includes a current collector; and a positive electrode active material layer on the current collector. The positive electrode active material layer includes a section I, a section II, and a section III in a width direction, and a porosity of the section II is in a range of about 5% to about 20% greater than porosities of the section I and the section III. In one or more example embodiments, the section I and the section III are positioned at an edge in the width direction of the positive electrode active material layer, and the section II is positioned between the section I and the section III.

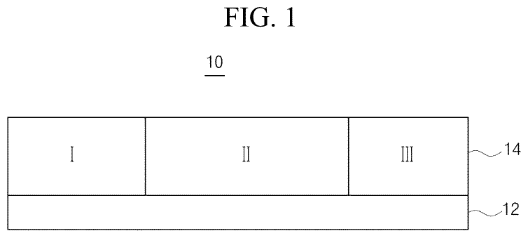

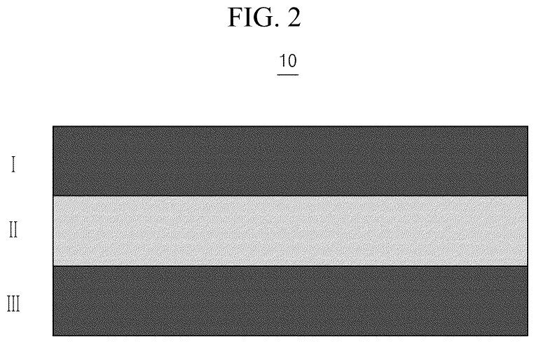

The positive electrode 10 according to one or more example embodiments, as shown in FIG. 1, includes the current collector 12 and the positive electrode active material layer 14 disposed on the current collector, and the positive electrode active material layer 14 includes the section I, the section II, and the section III. The section I, the section II, and the section III are located in the width direction, and as shown in FIG. 2 which is a plan view of the positive electrode, the section I, the section II, and the section III are separated by a boundary arranged in the width direction, for example, the longitudinal direction of the current collector 12.

In one or more example embodiments, the porosity of the section II is in a range of about 5% to about 20% larger than the porosity of the section I, and for example, may be in a range of about 10% to about 20% larger than that of the section I.

As such, when if the porosity of the section II, which is a center region at the width direction of the positive electrode active material layer, is in a range of about 5% to about 20% larger than the porosity of the section I and the section III which are positioned at the edge, the electrolyte impregnation of the center region may be enhanced, thereby substantially uniformly distributing the electrolyte in the active material layer. This enables to provide a battery exhibiting desired or improved battery performance and cycle-life characteristics. Thus, when if the battery having an increased height of about 70 mm or more has the configuration according to one or more example embodiments, desired or improved cycle-life characteristics may be exhibited.

In one or more example embodiments, the difference (gap) between the porosity of the section II, and the porosity of the section I or of the section III (porosity of the section II−porosity of the section I or the section III) is less than about 5%, the improvements effect in the electrolyte impregnation may not be sufficient. The difference (gap) of the porosity of the section II, and the porosity of the section I or the section III (porosity of the section II−porosity of the section I or the section III) is more than about 20%, the capacity difference of the positive electrode active material layer in the width direction increases, causing a potential deviation, thus, the cycle-life performance may be deteriorated.

In one or more example embodiment, the porosity of the section II may be in a range of about 15% to about 30%, or about 20% to about 30%. As the porosity of the section II, and the porosity of the section I or the section III satisfy the relationship, the porosity of the section II within about 15% to about 30% may provide a more uniform electrolyte impregnation and cycle-life characteristic.

The porosity of the section I and the section III may be in a range of about 1% to about 20%, or about 5% to about 20%. The porosity of the section I and the porosity of the section III may be identical to or different within the above range.

While the porosity of the section II and the porosity of the section I or the section III satisfy the above relationship, and when if the porosities of each section are within the above range, more uniform electrolyte impregnation and cycle-life retention may be exhibited.

In one or more example embodiments, the porosity may be measured from the scanning electron microscope (SEM) image for the cross-section of the exposed positive electrode active material layer. For example, the positive electrode active material layer is separated from the positive electrode, the section I, the section II, and the section III may be cut along with the width direction, and then processed using an ion milling device (e.g., IM4000PLUS available from Hitachi High-Technical) to expose the cross-section of the positive electrode active material layer. This procedure may provide the cross-section of the exposed positive electrode active material layer.

The measurement of the scanning electron microscope may be carried out by taking the reflection electron image for the cross-section of the exposed positive electrode active material layer, and the magnification in taking the images may be in a range of about 3000 times to about 5000 times.

The measured image may be subjected to a binarization image treatment using an image analysis post-processing software (e.g., ImageJ available from USA National Institutes of Health). According to the binarization image treatment, the binarization-treated image may be obtained in which the particle cross-section image may be changed to black, and the pores in the particles cross-section are changed to white. A ratio of pores in the target area may be calculated as porosity through the binarization treated images.

In one or more example embodiments, the width direction ratio of the section II may be in a range of about 20% to about 60%, about 20% to about 60%, or about 20% to about 55% of the total 100% of the positive electrode active material layer. When if the width of the section II is within the above range, the electrolyte impregnation effect owing to high porosity of the section II may be sufficiently obtained.

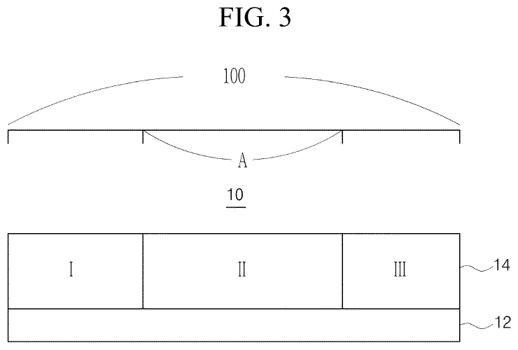

In one or more example embodiments, the width of the section II corresponds to the length A illustrated in FIG. 3, and thus, when if the entire width of the positive electrode active material layer is converted to about 100%, the length % of the A may be in a range of about 20% to about 54%. In one or more example embodiments, the width of the section II is critical, and each width of the section I and the section III may be adjusted as desired and thus, the width is not particularly limited. For example, when if the width of the section II is about 20%, the section I and section III may be adjusted as desired within about 80%.

In one or more example embodiments, the width direction ratio of the section I may be, based on the total width of the positive electrode active material layer, in a range of about 20% to about 40%, about 25% to about 35%, or about 30% to about 35%. Furthermore, the width direction ratio of the section III may be, based on the total 100% of the positive electrode active material layer, in a range of about 20% to about 40%, about 25% to about 35%, or about 30% to about 35%.

When if the width direction ratio of the section I or the section III satisfies the above range, the electrolyte impregnation of the positive electrode in the width direction may be substantially uniform, achieving desired or improved cycle-life characteristics.

In one or more example embodiments, the positive electrode active material layer includes a positive electrode active material, and may further include a binder and/or a conductive material.

For example, the positive electrode may further include an additive that may be configured as a sacrificial positive electrode.

An amount of the positive active material may be in a range of, about 90 wt % to about 99.5 wt % based on 100 wt % of the positive active material layer, and amounts of the binder and the conductive material may be respectively in a range of 0.5 wt % to 5 wt % based on 100 wt % of the positive active material layer.

For example, the following compounds represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹ₐGₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-g}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may be or include a high nickel-based positive electrode active material having a nickel amount that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may achieve high capacity, and may be applicable to a high-capacity, high-density rechargeable lithium battery.

The binder is configured to improve binding properties of positive electrode active material particles with one another and with a current collector. Examples of the binder may be or include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, or the like, but are not limited thereto.

The conductive material is included to provide electrode conductivity, and any suitable electrically conductive material may be used as a conductive material unless the electrically conductive material causes an adverse chemical change in the battery. Examples of the conductive material may include a carbon-based material such as at least one of natural graphite, artificial graphite, carbon black, acetylene black, Ketjen black, carbon fiber, carbon nanofiber, carbon nanotube, or the like; a metal-based material of a metal powder or a metal fiber including at least one of copper, nickel, aluminum, silver, or the like; a conductive polymer such as a polyphenylene derivative; or a mixture thereof.

The current collector may include Al, but is not limited thereto.

### Method of Preparing Positive Electrode:

The positive electrode according to one or more example embodiments may be prepared by coating a composition for a section II on a current collector and drying the section II composition, followed by coating a composition for a section I and a section III, drying the section I and section III composition, and compressing the section I and section III composition.

The compositions for the section I, the section II, and the section III composition may be prepared by adding a positive electrode active material, a binder, and a conductive material to a solvent.

Among the preparation process, a density of the compositions may be adjusted, or a particle size of the positive electrode active material may be adjusted, to prepare the positive electrode in which the porosity of the section II is in a range of about 5% to about 20% greater than the porosity of the section I and the section III, according to one or more example embodiments.

For example, the densities of the composition for the section I and the composition for the section III may be prepared to be in a range of about 80% to about 95%, or about 80% to about 90% based on the density 100% of the composition for the section II.

Alternatively, a large-particle positive electrode active material may be mixed with a small-particle positive electrode active material, and the resulting mixture may be used as the composition for the section I, the composition for the section II, and the composition for the section III. The large-particle positive electrode active material represents an active material having a larger average particle diameter (D50) than the small-particle positive electrode active material. For example, the large-particle positive electrode active material may have an average particle diameter (D50) in a range of about 5 μm to about 40 μm, or about 7 μm to about 30 μm, and the small-particle positive electrode active material may have an average particle diameter (D50) in a range of about 0.5 μm to about 12 μm, or about 1 μm to about 10 μm.

Herein, as the composition for the section I and the composition for the section III, the large-particle positive electrode active material and the small-particle positive electrode active material may be mixed at a weight ratio in a range of about 8:2 to about 8.4:1.6, a weight ratio in a range of about 8:2 to about 8.3:1.7, or a weight of 8:2 to 8.25:1.75. As the composition for the section II, the large-particle positive electrode active material and the small-particle positive electrode active material may be mixed at a weight ratio of about 7.5:2.5 to 5:5, or a weight ratio of about 7:3 to about 5:5.

When if the mixing ratios of the large-particle positive electrode active material and the small-particle positive electrode active material in the composition for the section I, the composition for the section II, and the composition for the section III, are all the same, this configuration is not desirable as the desired positive electrode may be not prepared. Alternatively, when if the large-particle positive electrode active material and the small-particle positive electrode active material is mixed at a weight ratio of about 8:2 to about 8.4:1.6 weight ratio and used for the composition for the section II, this configuration is not suitable as the desired positive electrode may be not prepared.

The solvent may be or include an organic solvent such as N-methyl pyrrolidone.

### Rechargeable Lithium Battery:

Another example embodiment includes a rechargeable lithium battery including the positive electrode, a negative electrode, and a non-aqueous electrolyte.

### Negative Electrode:

The negative electrode for a rechargeable lithium battery includes a current collector, and a negative electrode active material layer on the current collector. The negative electrode active material layer includes a negative electrode active material, and may further include a binder and/or a conductive material.

For example, the negative electrode active material layer may include the negative electrode active material at about 90 wt % to about 99 wt % and the binder at about 1 wt % to about 5 wt %. When if the negative electrode active material layer further includes the conductive material, the negative electrode active material may be included at about 90 wt % to about 99 wt %, the binder may be included at about 0.5 wt % to about 5 wt %, and the conductive material may be included at about 0.5 wt % to about 5 wt %.

The negative active material includes at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may be or include a carbon material, and for example, crystalline carbon, amorphous carbon, or a combination thereof. The crystalline carbon may be of unspecified shape, sheet, flake, spherical, or fiber shaped natural graphite or artificial graphite, and the amorphous carbon may be or include at least one of a soft carbon, a hard carbon, a mesophase pitch carbonization product, fired coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based material, or a Sn-based negative active material. The Si-based negative active material may be or include at least one of silicon, a Si—C composite, SiOₓ (0<x<2), a Si-Q alloy (wherein Q is or includes at least one of an alkali metal, an alkaline-earth metal, a Group 13 element, a Group 14 element (except for Si) a Group 15 element, a Group 16 element, a transition metal, a rare earth element, and a combination thereof), or a combination thereof. The Sn-based negative active material may be or include at least one of Sn, SnO₂, a Sn-based alloy, or a combination thereof.

The silicon-carbon composite may be or include a composite of silicon and amorphous carbon. The carbon may include amorphous carbon, or amorphous carbon and crystalline carbon. The crystalline carbon may be of unspecified shape, sheet, flake, spherical, or fiber shaped natural graphite, artificial graphite, or a combination. The amorphous carbon may be or include at least one of a soft carbon, a hard carbon, a mesophase pitch carbonization product, fired coke, and the like.

The silicon-carbon composite may include silicon particles, and an amorphous carbon coated on the surface of the silicon particle. For example, the silicon-carbon composite may include silicon particles, and an amorphous carbon coating layer on the surface of the silicon particle. In other example embodiments, the silicon-carbon composite may include a secondary particle in which silicon primary particles are agglomerated, and an amorphous carbon coating layer (shell) positioned on the secondary particle. The amorphous carbon is present between the silicon primary particles, for example, to coat on the silicon primary particles. For example, the secondary particle may be distributed in an amorphous carbon matrix. The silicon primary particles may be or include nano silicon particles. The nano silicon particle may have an average particle diameter in a range of about 10 nm to about 900 nm, about 10 nm to about 800 nm, about 10 nm to about 500 nm, about 10 nm to about 300 nm, or about 10 nm to about 200 nm. When if the particle diameter of the nano silicon particles is within the above range, the substantial volume expansion caused during charge and discharge may be reduced or suppressed, and a breakage of the conductive path due to crushing of particle may be reduced or prevented. In some example embodiments, the particle diameter of the silicon secondary particle is not particularly limited.

The thickness of the amorphous carbon coating layer may be adjusted as desired, but for example, in a range of about 2 nm to about 800 nm, about 5 nm to about 600 nm, about 10 nm to about 400 nm, or about 20 nm to about 200 nm. In one or more example embodiments, the thickness of the amorphous carbon coating layer may be measured by a SEM image or a TEM image for the cross-section of the silicon-carbon composite, but may also be measured by any techniques to measure the thickness of the amorphous carbon coating layer.

A particle diameter of the silicon-carbon composite may be adjusted as desired, and for example, about 30 μm or less, for example, about 1 μm to about 30 μm, about 2 μm to about 25 μm, about 3 μm to about 20 μm, or about 5 μm to about 15 μm.

Based on 100 wt % of the silicon-carbon composite, an amount of the silicon particles may be in a range of about 30 wt % to about 70 wt %, or about 40 wt % to about 65 wt %. An amount of the amorphous carbon may be, based on the total 100 wt % of the silicon-carbon composite, in a range of about 30 wt % to about 70 wt %, or about 35 wt % to about 60 wt %. When if the amounts of the silicon particles and the amorphous carbon are within the above range, a higher capacity may be realized.

In some example embodiments, the silicon-carbon composite may include a core including silicon particles and crystalline carbon, and an amorphous carbon coating layer on a surface of the core. For example, the silicon-carbon composite may include a core including secondary particles where the silicon primary particles and crystalline carbon are agglomerated, and an amorphous carbon coating layer on the core. The amorphous carbon may be present between the silicon primary particles, or between the crystalline carbon, allowing the amorphous carbon to be filled between the silicon primary particles and the crystalline carbon.

When if the silicon-carbon composite includes the silicon particles, the crystalline carbon, and the amorphous carbon, based on the total 100 wt % of the silicon particles, the crystalline carbon, and the amorphous carbon, an amount of the crystalline carbon may be in a range of about 10 wt % to about 70 wt %, or about 20 wt % to about 60 wt %. An amount of the amorphous carbon may be in a range of about 20 wt % to about 40 wt %, or about 20 wt % to about 30 wt %, and an amount of the silicon particle may be in a range of about 10 wt % to about 70 wt %, or about 10 wt % to about 60 wt %.

In the negative electrode according to some example embodiments, the negative active material may include a carbon-based negative active material, together with the silicon-based negative active material. When if the silicon-based negative active material is used together with the carbon-based negative active material, a mixing ratio of the silicon-based negative active material and the carbon-based negative active material may be in a range of about 1:99 to about 50:50 by weight ratio. In some example embodiments, the mixing ratio of the silicon-based negative active material and the carbon-based negative active material may be in a range of about 5:95 to about 20:80 by weight ratio.

The binder improves binding properties of negative active material particles with one another and with a current collector. The binder may include a non-aqueous binder, an aqueous binder, a dry binder, or a combination thereof.

The non-aqueous-based binder may include at least one of polyvinylchloride, carboxylated polyvinylchloride, polyvinyl fluoride, an ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinyl pyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acryl resin, a phenol resin, an epoxy resin, polyvinyl alcohol, or a combination thereof.

When if the aqueous binder is used as a negative electrode binder, a cellulose-based compound may be further used to provide viscosity. The cellulose-based compound includes one or more of carboxymethyl cellulose, hydroxypropylmethyl cellulose, methyl cellulose, or alkali metal salts thereof. The alkali metal may be or include at least one of Na, K, or Li.

The conductive material is included to provide electrode conductivity, and any electrically conductive material may be used as a conductive material unless the electrically conductive material causes an adverse chemical change in the battery. Examples of the conductive material may be or include a carbon-based material such as at least one of natural graphite, artificial graphite, carbon black, acetylene black, ketjen black, a carbon fiber, a carbon nanofiber, carbon nanotube, or the like; a metal-based material of a metal powder or a metal fiber including at least one of copper, nickel, aluminum, silver, and the like; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, and a combination thereof.

### Electrolyte:

The electrolyte for a rechargeable lithium battery includes a non-aqueous organic solvent and a lithium salt.

The non-aqueous organic solvent is configured as a medium that transmits ions taking part in the electrochemical reaction of a battery.

The non-aqueous organic solvent may include at least one of a carbonate-based, ester-based, ether-based, ketone-based, alcohol-based, aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include at least one of methyl acetate, ethyl acetate, n-propyl acetate, dimethyl acetate, methyl propionate, ethyl propionate, decanolide, γ-butyrolactone, mevalonolactone, valerolactone, caprolactone, or the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, or the like. The ketone-based solvent may include cyclohexanone, or the like. The alcohol-based solvent may include at least one of ethanol, isopropyl alcohol, and the like. The aprotic solvent may include at least one of nitriles such as R—CN (wherein R is a C2 to C20 linear, branched, or cyclic hydrocarbon group, and may include a double bond, an aromatic ring, or an ether bond, and the like); amides such as dimethylformamide; dioxolanes such as 1,3-dioxolane, 1,4-dioxolane, and the like; sulfolanes, or the like.

The organic solvent may be included alone or in a mixture of two or more solvents.

When if the carbonate-based solvent is included, the cyclic carbonate and the linear carbonate may be included together therewith, and the cyclic carbonate and the linear carbonate may be mixed at a volume ratio in a range of about 1:1 to about 1:9.

The electrolyte may further include at least one of vinylethyl carbonate, vinylene carbonate, difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, or a combination thereof, as an additive.

The lithium salt dissolved in an organic solvent is configured to supply a battery with lithium ions, to operate the rechargeable lithium battery, and to improve transportation of the lithium ions between positive and negative electrodes. Examples of the lithium salt include one or at least two supporting electrolyte salt such as or including at least LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂), where x and y are an integer in a range of 1 to 20, lithium trifluoromethane sulfonate, lithium tetrafluoroethanesulfonate, lithium difluorobis(oxalato)phosphate (LiDFOP), lithium bis(oxalato) borate (LiBOB).

### Separator:

A separator may be present between the positive electrode and the negative electrode depending on a type of rechargeable lithium battery. The separator may include at least one of polyethylene, polypropylene, polyvinylidene fluoride or multi-layers thereof having two or more layers and may be a mixed together multilayer such as a polyethylene/polypropylene double-layered separator, a polyethylene/polypropylene/polyethylene triple-layered separator, a polypropylene/polyethylene/polypropylene triple-layered separator, and the like.

The separator may include a porous substrate and a coating layer including an organic material, an inorganic material, or a combination thereof on one surface, or on both surfaces (e.g., one or two opposing surfaces), of the porous substrate.

The porous substrate may be or include a polymer film or a film formed of or including any one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acryl-based polymer.

The inorganic material may be or include an inorganic particle such as at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and an inorganic material may be mixed in one coating layer, or a coating layer including an organic material and a coating layer including an inorganic material may be stacked together.

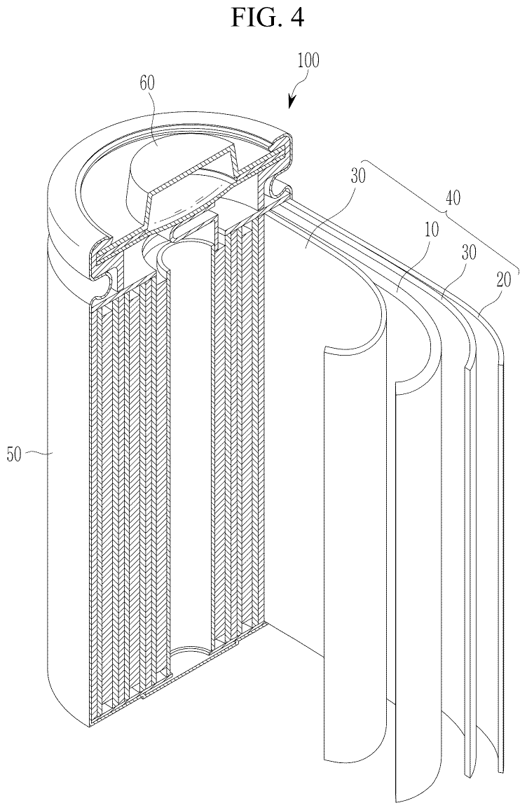

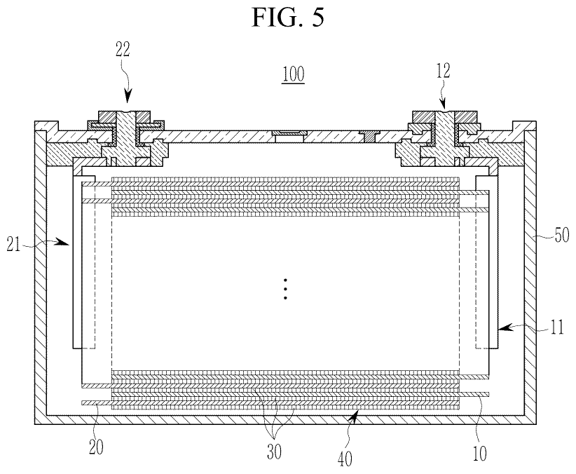

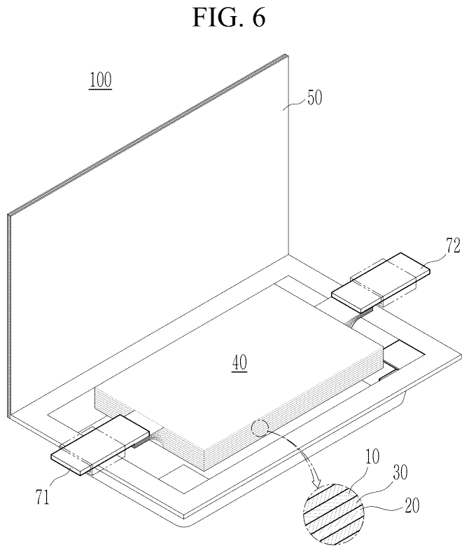

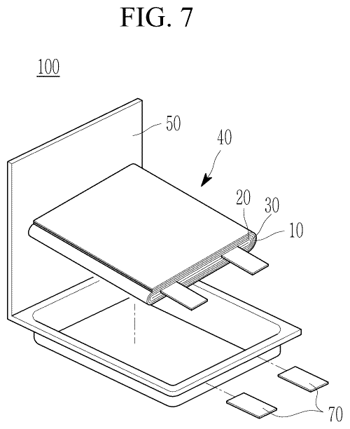

The rechargeable lithium battery may be classified into cylindrical, prismatic, pouch, or coin-type batteries, and the like, depending on the shape thereof. FIG. 4 to FIG. 7 are schematic views illustrating a rechargeable lithium battery according to an example embodiment, and FIG. 4 shows a cylindrical battery, FIG. 5 shows a prismatic battery, and FIG. 6 and FIG. 7 show pouch-type batteries. Referring to FIGS. 4 to 7, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte (not shown). The rechargeable lithium battery 100 may include a sealing member 60 that seals the case 50, as shown in FIG. 4. In FIG. 5, the rechargeable lithium battery 100 may include a positive electrode lead tab 11 and a positive terminal 12 connected to the positive electrode lead tab 11, a negative electrode lead tab 21, and a negative terminal 22 connected to the negative electrode lead tab 21. As shown in FIG. 7, the rechargeable lithium battery 100 may include an electrode tab 70, which may form an electrical path for inducing the current formed in the electrode assembly 40 to the outside of the battery 100, or a positive electrode tab 71 and a negative electrode tab 72, as shown in FIG. 6.

The rechargeable lithium battery according to an example embodiment may be applicable to, e.g., automobiles, mobile phones, and/or various suitable types (or kinds) of electric devices, as non-limiting examples.

The following Examples and Comparative Examples are provided in order to highlight characteristics of one or more example embodiments, but it is understood that the Examples and Comparative Examples are not to be construed as limiting the scope of the example embodiments, nor are the Comparative Examples to be construed as being outside the scope of the example embodiments. Further, it is understood that the example embodiments are not limited to the particular details described in the Examples and Comparative Example.

### Example 1

### Synthesis of First Lithium Metal Composite Oxide:

Nickel sulfate hexahydrate (NiSO₄·6H₂O), cobalt sulfate pentahydrate (CoSO4·5H₂O), and aluminum nitrate (Al(NO₃)₃) were dissolved in an ion exchange water to prepare a mixed aqueous solution. Herein, a mixing ratio of nickel sulfate hexahydrate (NiSO₄·6H₂O), cobalt sulfate pentahydrate (CoSO₄·5H₂O), aluminum nitrate (Al(NO₃)₃) was adjusted in order to have a mole ratio of Ni, Co, and Al to be 90:5:5.

NaOH was added to the mixed aqueous solution so that the pH thereof became 9. In the procedure, hydrate salts of each metal elements were co-precipitated to prepare a composite hydrate. The composite hydrate was heat-treated at 600° C. to prepare a composite oxide.

The obtained composite oxide and lithium hydroxide were mixed in order to have a mole ratio (Li/Me ratio) of metal element (Me) of the composite oxide and Li of lithium hydroxide to be 1:1.020.

The resulting mixture was added to a sintering furnace and sintered under the following conditions. The mixture was treated by increasing a temperature at a rate of 3° C./min under a 95% oxygen atmosphere to 650° C., by increasing a temperature at a rate of 1° C./min to 750° C., and maintaining at 750° C. for 3 hours.

The resulting sintered product was pulverized and then washed with water to prepare a first lithium metal composite oxide (LiNi_{0.9}Co_{0.05}Al_{0.05}O₂) with D50 of 10 m.

### Synthesis of Second Lithium Metal Composite Oxide:

A composite oxide was prepared by the same procedure as in the synthesis of the first lithium metal composite oxide, with a difference that NaOH was added to the mixed aqueous solution in order to adjust a pH of 11.

The obtained composite oxide and lithium hydroxide were mixed in order to have a mole ratio (Li/Me ratio) of metal element (Me) of the composite oxide and Li of lithium hydroxide to be 1:1.020.

The resulting mixture was added to a sintering furnace and sintered under the following conditions. The mixture was treated by increasing a temperature at a rate of 3° C./min under a 95% oxygen atmosphere to 650° C., by increasing a temperature at a rate of 1° C./min to 750° C., and maintaining for 750° C. for 3 hours.

The resulting sintered product was pulverized and then washed with water to prepare a first lithium metal composite oxide (LiNi_{0.9}Co_{0.05}Al_{0.05}O₂) with D50 of 5 μm.

A LiNi_{0.9}Co_{0.05}Al_{0.05}O₂ positive electrode active material in which the first lithium metal composite oxide and the second lithium metal composite oxide were mixed at a weight ratio 8:2 of 97 wt %, a polyvinylidene fluoride binder of 2 wt %, and a Ketjen black conductive agent of 1 wt % were mixed in an N-methyl pyrrolidone solvent to prepare a positive electrode active material layer slurry A.

A LiNi_{0.9}Co_{0.05}Al_{0.05}O₂ positive electrode active material in which the first lithium metal composite oxide and the second lithium metal composite oxide were mixed at a weight ratio of 7:3 of 97 wt %, a polyvinylidene fluoride binder of 2 wt %, and a Ketjen black conductive agent of 1 wt % were mixed in an N-methyl pyrrolidone solvent to prepare a positive electrode active material layer slurry B.

A section I (width: 20 mm), a section II (width: 25 mm) and a section III (width: 20 mm) were separated in the width direction of an Al current collector with a width of 65 mm, and then the positive electrode active material layer slurry B was coated on the section I and the section III, and the positive electrode active material layer slurry A was coated on the section II, dried, and compressed to prepare a positive electrode (thickness: 140 μm).

Artificial graphite of 97 wt %, a styrene-butadiene rubber of 2 wt %, and carboxymethyl cellulose of 1 wt % were mixed in a water solvent to prepare a negative electrode active material layer slurry.

The negative electrode active material layer slurry was coated on a copper current collector and dried followed by compressing to prepare a negative electrode.

Using the positive electrode, the negative electrode, and an electrolyte, a cylindrical full cell with a length of 80 mm was fabricated. The electrolyte was used by dissolving 1.15M LiPF₆ in a mixed solvent of ethylene carbonate, ethylmethyl carbonate, and dimethyl carbonate (in a volume ratio of 3:5:2).

### Example 2

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio of 6:4 of 97 wt %, a polyvinylidene fluoride binder of 2 wt %, and a Ketjen black conductive agent of 1 wt % were mixed in an N-methyl pyrrolidone solvent to prepare a positive electrode active material layer slurry B.

### Example 3

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio 8.25:1.75, a polyvinylidene fluoride binder of 2 wt %, and a Ketjen black conductive agent of 1 wt % were mixed in an N-methyl pyrrolidone solvent to prepare a positive electrode active material layer slurry A and a LiNi_{0.9}Co_{0.05}Al_{0.05}O₂ positive electrode active material in which the first lithium metal composite oxide and the second lithium metal composite oxide were mixed at a weight ratio of 5:5 of 97 wt %, a polyvinylidene fluoride binder of 2 wt %, and a Ketjen black conductive agent of 1 wt % were mixed in an N-methyl pyrrolidone solvent to prepare a positive electrode active material layer slurry B.

### Example 4

A section I (width: 15 mm), a section II (width: 35 mm) and a section III (width: 15 mm) were separated in the width direction of an Al current collector with a width of 65 mm, and then the positive electrode active material layer slurry B was coated on the section I and the section III, and the positive electrode active material layer slurry A was coated on the section II, dried, and compressed to prepare a positive electrode (thickness: 140 μm).

Using the positive electrode, a cylindrical full cell with a length of 80 mm was fabricated by the same procedure as in Example 1.

### Example 5

A section I (width: 22 mm), a section II (width: 20 mm) and a section III (width: 23 mm) were separated in the width direction of an Al current collector with a width of 65 mm, and then the positive electrode active material layer slurry B was coated on the section I and the section III, and the positive electrode active material layer slurry A was coated on the section II, dried, and compressed to prepare a positive electrode (thickness: 140 μm).

Using the positive electrode, a cylindrical full cell with a length of 80 mm was fabricated by the same procedure as in Example 1.

### Example 6

A section I (width: 26 mm), a section II (width: 13 mm) and a section III (width: 26 mm) were separated in the width direction of an Al current collector with a width of 65 mm, and then the positive electrode active material layer slurry B was coated on the section I and the section III, and the positive electrode active material layer slurry A was coated on the section II, dried, and compressed to prepare a positive electrode (thickness: 140 μm.

Using the positive electrode, a cylindrical full cell with a length of 80 mm was fabricated by the same procedure as in Example 1.

### Comparative Example 1

A LiNi_{0.9}Co_{0.05}Al_{0.05}O₂ positive electrode active material in which the first lithium metal composite oxide and the second lithium metal composite oxide were mixed at a weight ratio of 8:2 constituting 97 wt %, a polyvinylidene fluoride binder constituting 2 wt %, and a Ketjen black conductive agent constituting 1 wt % were mixed in an N-methyl pyrrolidone solvent to prepare a positive electrode active material layer slurry B.

A section I (width: 20 mm), a section II (width: 25 mm) and a section III (width: 20 mm) were separated in the width direction of an Al current collector with a width of 65 mm, and then the positive electrode active material layer slurry B was coated on the section I and the section III, and the positive electrode active material layer slurry A of Example 1 was coated on the section II, dried, and compressed to prepare a positive electrode (thickness: 140 μm).

Using the positive electrode, a cylindrical full cell with a length of 80 mm was fabricated by the same procedure as in Example 1.

### Comparative Example 2

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio of 7:3 constituting 97 wt %, a polyvinylidene fluoride binder constituting 2 wt %, and a Ketjen black conductive agent constituting 1 wt % were mixed in an N-methyl pyrrolidone solvent to prepare a positive electrode active material layer slurry A.

### Comparative Example 3

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio of 8.25:1.75 constituting 97 wt %, a polyvinylidene fluoride binder constituting 2 wt %, and a Ketjen black conductive agent constituting 1 wt % were mixed in an N-methyl pyrrolidone solvent to prepare a positive electrode active material layer slurry B.

### Comparative Example 4

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio 7:3, a polyvinylidene fluoride binder constituting 2 wt %, and a Ketjen black conductive agent constituting 1 wt % were mixed in an N-methyl pyrrolidone solvent to prepare a positive electrode active material layer slurry A and a LiNi_{0.9}Co_{0.05}Al_{0.05}O₂ positive electrode active material in which the first lithium metal composite oxide and the second lithium metal composite oxide were mixed at a weight ratio of 8.25:1.75 constituting 97 wt %, a polyvinylidene fluoride binder constituting 2 wt %, and a Ketjen black conductive agent constituting 1 wt % were mixed in an N-methyl pyrrolidone solvent to prepare a positive electrode active material layer slurry B.

### Comparative Example 5

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio of 7.2:2.8 constituting 97 wt %, a polyvinylidene fluoride binder constituting 2 wt %, and a Ketjen black conductive agent constituting 1 wt % were mixed in an N-methyl pyrrolidone solvent to prepare a positive electrode active material layer slurry B.

### Comparative Example 6

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio 8.5:1.5, a polyvinylidene fluoride binder constituting 2 wt %, and a Ketjen black conductive agent constituting 1 wt % were mixed in an N-methyl pyrrolidone solvent to prepare a positive electrode active material layer slurry A and a LiNi_{0.9}Co_{0.05}Al_{0.05}O₂ positive electrode active material in which the first lithium metal composite oxide and the second lithium metal composite oxide were mixed at a weight ratio of 5:5 constituting 97 wt %, a polyvinylidene fluoride binder constituting 2 wt %, and a Ketjen black conductive agent constituting 1 wt % were mixed in an N-methyl pyrrolidone solvent to prepare a positive electrode active material layer slurry B.

### Comparative Example 7

A positive electrode and a cylindrical full cell were fabricated by the same procedure as in Example 1, with a difference that a LiNi_{0.9}Co_{0.05}Al_{0.05}O₂ positive electrode active material in which the first lithium metal composite oxide and the second lithium metal composite oxide were mixed at a weight ratio of 9:1 constituting 97 wt %, a polyvinylidene fluoride binder constituting 2 wt %, and a Ketjen black conductive agent constituting 1 wt % were mixed in an N-methyl pyrrolidone solvent to prepare a positive electrode active material layer slurry A.

The configurations of Examples 1 to 6 and of Comparative Examples 1 to 7 were summarized in Table 1 below. In Table 1, a mixing ratio of the slurry A and the slurry B was a weight ratio of the first lithium metal composite oxide and the second lithium metal composite oxide. In Table 1, the width ratio (%) represents the width direction ratio based on the total width 100% of the positive electrode active material layer.

TABLE 1

| | Slurry A | Slurry B | Width of section I | Width of section II | Width of section |
|---|---|---|---|---|---|
| | (mixing | (mixing | (mm), width ratio | (mm), width ratio | III (mm), width |
| | ratio) | ratio) | (%) | (%) | ratio (%) |
| Example 1 | 8:2 | 7:3 | 20, 30.77 | 25, 38.46 | 20, 30.77 |
| Example 2 | 8:2 | 6:4 | 20, 30.77 | 25, 38.46 | 20, 30.77 |
| Example 3 | 8.25:1.75 | 5:5 | 20, 30.77 | 25, 38.46 | 20, 30.77 |
| Example 4 | 8:2 | 7:3 | 15, 23.1 | 35, 53.8 | 15, 23.1 |
| Example 5 | 8:2 | 7:3 | 22, 33.8 | 20, 30.8 | 23, 35.4 |
| Example 6 | 8:2 | 7:3 | 26, 40 | 13, 20 | 26, 40 |
| Comparative | 8:2 | 8:2 | 20, 30.77 | 25, 38.46 | 20, 30.77 |
| Example 1 | | | | | |
| Comparative | 7:3 | 7:3 | 20, 30.77 | 25, 38.46 | 20, 30.77 |
| Example 2 | | | | | |
| Comparative | 8:2 | 8.25:1.75 | 20, 30.77 | 25, 38.46 | 20, 30.77 |
| Example 3 | | | | | |
| Comparative | 7:3 | 8.25:1.75 | 20, 30.77 | 25, 38.46 | 20, 30.77 |
| Example 4 | | | | | |
| Comparative | 8:2 | 7.2:2.8 | 20, 30.77 | 25, 38.46 | 20, 30.77 |
| Example 5 | | | | | |
| Comparative | 8.5:1.5 | 5:5 | 20, 30.77 | 25, 38.46 | 20, 30.77 |
| Example 6 | | | | | |
| Comparative | 9:1 | 7:3 | 20, 30.77 | 25, 38.46 | 20, 30.77 |
| Example 7 | | | | | |

### Experimental Example 1) Evaluation of Porosity

After separating the positive electrode active material layer from the positive electrode according to Examples 1 to 6 and Comparative Examples 1 to 7, a section I, a section II, and a section III was cut along with the width direction, and then processed using an ion milling device (e.g., IM4000PLUS available from Hitachi High-Technical) to expose the cross-section of the positive electrode active material layer.

For the exposed cross-section of the positive electrode active material layer, the reflection electron image was taken and obtained (magnification: 5000 times). The image was subjected to a binarization image treatment using an image analysis processing software (e.g., ImageJ available from USA National Institutes of Health) to calculate a ratio of the pores in the target area through the obtained binarization image.

The results are shown in Table 2 below. The difference between the porosity of the section II, and the porosities of the section I and the section III (porosity of the section II−(porosity of the section I or the section III)) are shown in Table 2 below.

### Experimental Example 2) Evaluation of Electrolyte Impregnation

In the cells according to Examples 1 to 6 and Comparative Examples 1 to 7, the electrolyte impregnation of the section I, the section II, and the section III was measured.

The measurement for impregnation was found by injecting the electrolyte to fabricate a cell, disassembling the cell after 1 hour, and visually observing the state of the separator in contact with the positive electrode.

The results are shown in Table 2 below.

### Experimental Example 3) Evaluation of Capacity Retention

The cells according to Examples 1 to 6 and Comparative Examples 1 to 7 were charged and discharged at 1.0 C once in the range of 4.2 V to 2.5 V at 10° C., and charged and discharged at 0.5 C for 200 cycles. A ratio of discharge capacity at 0.5 C for 100 cycles relative to discharge capacity at 1.0 C once was calculated. The results are shown in Table 2 as a capacity retention.

In the positive electrodes according to Examples 1 to 6 and Comparative Examples 1 to 7, a ratio of width of the section II based on the entire width of the positive electrode active material layer was calculated. The results are shown in Table 2.

TABLE 2

| | Porosity (%) | | | Width ratio | | Capacity |
|---|---|---|---|---|---|---|
| | | I section and | Difference | of section | Impregnation | retention |
| | II section | section II | of porosity | II (%) | of electrolyte | (%) |
| Example 1 | 20 | 15 | 5 | 38.46 | Uniform | 84 |
| Example 2 | 20 | 10 | 10 | 38.46 | Uniform | 89 |
| Example 3 | 25 | 5 | 20 | 38.46 | Uniform | 80 |
| Example 4 | 20 | 15 | 5 | 53.8 | Uniform | 86 |
| Example 5 | 20 | 15 | 5 | 30.8 | Uniform | 83 |
| Example 6 | 20 | 15 | 5 | 20 | Uniform | 80 |
| Comparative | 20 | 20 | 0 | 38.46 | No | 70 |
| Example 1 | | | | | impregnation | |
| | | | | | at section II | |
| Comparative | 15 | 15 | 0 | 38.46 | No | 65 |
| Example 2 | | | | | impregnation | |
| | | | | | at section II | |
| Comparative | 20 | 25 | −5 | 38.46 | No | 56 |
| Example 3 | | | | | impregnation | |
| | | | | | at section II | |
| Comparative | 15 | 25 | −10 | 38.46 | No | 50 |
| Example 4 | | | | | impregnation | |
| | | | | | at section II | |
| Comparative | 20 | 16 | 4 | 38.46 | No | 73 |
| Example 5 | | | | | impregnation | |
| | | | | | at section II | |
| Comparative | 30 | 5 | 25 | 38.46 | Uniform | 70 |
| Example 6 | | | | | | |
| Comparative | 40 | 15 | 25 | 38.46 | Uniform | 62 |
| Example 7 | | | | | | |

As indicated in Table 2, the cells of Examples 1 to 6 in which the porosity of the section II is 5% to 20% larger than the porosities of the section I and the section III exhibited a uniform electrolyte impregnation and high capacity retention.

Whereas, in the cells of Comparative Examples 1 and 2 in which the porosity of the section II is same with the porosities of the section I and the section III, the electrolyte was not impregnated in the section II, that is, a reduced electrolyte impregnation and a low capacity retention were exhibited.

Furthermore, the cells of Comparative Examples 3 and 4 in which the porosity of the section II is smaller than the porosities of the section I and the section III exhibited non-uniform electrolyte impregnation and abruptly low capacity retention.

The cells of Comparative Examples 5 to 6 in which the porosity of the section II is 4% larger, or 25% larger, than the porosities of the section I and the section III exhibited low capacity retention.

While this disclosure has been described in connection with what is presently considered to be practical example embodiments, it is to be understood that the disclosure is not limited to the disclosed example embodiments, but, on the contrary, is intended to cover various modifications and equivalent arrangements included within the spirit and scope of the appended claims.

What is claimed is:

1. A positive electrode for a rechargeable lithium battery, the positive electrode comprising:
a current collector; and
a positive electrode active material layer on the current collector,
wherein the positive electrode active material layer comprises a section I, a section II, and a section III in a width direction, and
the section I and the section III are positioned at an edge in the width direction of the positive electrode active material, and the section II is positioned between the section I and the section III, and a porosity of the section II is about 5% to about 20% greater than porosities of the section I and the section III.

2. The positive electrode for a rechargeable lithium battery of claim 1, wherein the porosity of the section II is in a range of about 10% to about 20% greater than the porosities of the section I and the section III.

3. The positive electrode for a rechargeable lithium battery of claim 1, wherein a ratio of the section II in a width direction is in a range of about 20% to about 60% of the total width of the positive electrode active material layer.

4. The positive electrode for a rechargeable lithium battery of claim 1, wherein the porosity of the section II is in a range of about 15% to about 30%.

5. The positive electrode for a rechargeable lithium battery of claim 1, wherein the porosity of the section II is in a range of about 20% to about 30%.

6. The positive electrode for a rechargeable lithium battery of claim 1, wherein the porosity of the section I is in a range of about 5% to about 20%.

7. The positive electrode for a rechargeable lithium battery of claim 1, wherein the porosity of the section III is in a range of about 5% to about 20%.

8. The positive electrode for a rechargeable lithium battery of claim 1, wherein a ratio of the section I in a width direction is in a range of about 20% to about 40% of the total width of the positive electrode active material layer.

9. The positive electrode for a rechargeable lithium battery of claim 8, wherein a ratio of the section I in a width direction is in a range of about 25% to about 35% of the total width of the positive electrode active material layer.

10. The positive electrode for a rechargeable lithium battery of claim 1, wherein a ratio of the section III in a width direction is in a range of about 20% to about 40% of the total width of the positive electrode active material layer.

11. The positive electrode for a rechargeable lithium battery of claim 10, wherein a ratio of the section III in a width direction is in a range of about 25% to about 35% of the total width of the positive electrode active material layer.

12. The positive electrode for a rechargeable lithium battery of claim 1, wherein the positive electrode active material layer comprises a large-particle positive electrode active material, and small-particle positive electrode active material.

13. The positive electrode for a rechargeable lithium battery of claim 12, wherein a mixing ratio of the large-particle positive electrode active material and the small-particle positive electrode active material is in a range of about 8:2 to about 8.4:1.6 by weight ratio.

14. A rechargeable lithium battery, comprising:
a positive electrode of claim 1;
a negative electrode; and
a non-aqueous electrolyte.

15. The rechargeable lithium battery of claim 14, wherein the rechargeable lithium battery is a cylindrical battery.

16. The rechargeable lithium battery of claim 14, wherein the rechargeable lithium battery has a height in a range of about 70 mm to about 100 mm.
